(19) United States
(12) Patent Application Publication
(10) Pub. No.: US 2016/0209600 A1
(43) Pub. Date: Jul. 21, 2016

(54) ALIGNMENT DEVICE FOR FIBER FERRULE, FIBER ALIGNMENT MACHINE AND FIBER ALIGNMENT METHOD

(71) Applicant: TYCO ELECTRONICS (SHANGHAI) CO. LTD., Shanghai (CN)

(72) Inventors: Hang LEE, Shanghai (CN); Zongshen LENG, Shanghai (CN); Chuanwu CHEN, Shanghai (CN); Huifeng ZHAO, Shanghai (CN); Yongjun YUAN, Shanghai (US)

(73) Assignee: Tyco Electronics (Shangahi) Co., Ltd., Shanghai (CN)

(21) Appl. No.: 15/025,320

(22) PCT Filed: Sep. 1, 2014
(86) PCT No.: PCT/IB2014/064171

§ 371 Date: Mar. 28, 2016

(30) Foreign Application Priority Data
Sep. 27, 2013 (CN) 201310449291.8

(51) Int. Cl. G02B 6/38

(52) U.S. Cl. CPC G02B 6/3871; G02B 6/3898; G02B 6/3843

(57) ABSTRACT

Disclosed is an alignment device for a fiber ferrule comprises: a ferrule holding part configured to hold the fiber ferrule in a manner that the fiber ferrule is rotatable about its central axis; a ferrule rotating part configured to rotate the ferrule about the central axis by a predetermined angle; and a marking part configured to mark on an outer surface of the ferrule rotated by the predetermined angle. Also disclosed is a fiber alignment machine comprises the above alignment device and a first ferrule grip device gripping a ferrule out of a ferrule clamp and then moving the ferrule to a ferrule holding part. The present invention also relates to a fiber alignment method comprising holding a ferrule in a ferrule holding part in a vertical direction; rotating the ferrule about a central axis thereof by a predetermined angle; and marking on an outer surface the ferrule rotated by the predetermined angle. The present invention can effectively improve the efficiency of an alignment operation of the fiber ferrule.

### CROSS-REFERENCE TO RELATED APPLICATION

This application claims the benefit of Chinese Patent Application No. CN201310449291.8 filed on Sep. 27, 2013 in the State Intellectual Property Office of China, the whole disclosure of which is incorporated herein by reference.

### BACKGROUND OF THE INVENTION

1. Field of the Invention

Embodiments of the present invention generally relate to fiber alignment, in particular to an alignment device for a fiber ferrule, a fiber alignment machine and a fiber alignment method.

2. Description of the Related Art

For a bare fiber inserted into a ceramic ferrule, when two fibers are connected, profiles of two ceramic ferrules are just for a match. However, due to various reasons, the bare fiber is always not aligned with a central axis of the ceramic ferrule. If such two fibers deviating from the central axis of the ceramic ferrules are connected with each other, the two bare fibers will not be completely abutted with each other, which introduces signal leakages.

In order to avoid the above problem due to the deviation of the fiber from the central axis of the ceramic ferrule, an existing method is to perform manual alignment, which may greatly increase labors and decrease production efficiency. Further, the manual alignment requires very high technology and patience of an operator, and is especially not suitable for automatic productions.

### SUMMARY OF THE INVENTION

The present invention has been made to overcome or alleviate at least one aspect of the above mentioned disadvantages.

According to an aspect of the present invention, there is provided an alignment device for a fiber ferrule comprising: a ferrule holding part configured to hold the fiber ferrule in a manner that the fiber ferrule is rotatable about its central axis; a ferrule rotating part configured to rotate the ferrule about the central axis by a predetermined angle; and a marking part configured to mark on an outer surface of the ferrule rotated by the predetermined angle.

In an exemplary embodiment of the present invention, the marking part comprises a marking pen and a first driving part for driving the marking pen so that a penpoint of the marking pen moves towards and away from the ferrule. Further, the ferrule holding part comprises a first clamping block and a second clamping block opposite to each other, each of which is provided with one recess, and both of the recesses are opposite to each other to form a portion for partially inserting a ferrule body of the ferrule. Furthermore, the portion for partially inserting the ferrule body of the ferrule comprises a circular hole. In addition, the first clamping block is elastically abutted against the second clamping block.

In another exemplary embodiment of the present invention, the ferrule rotating part comprises an alignment claw adapted to releasably clamp an upper end of the ferrule and a second driving part for driving the alignment claw to move along a circular arc about the central axis. Further, the alignment device comprises an alignment platform provided with a circular arc shape through-slot which guides the alignment claw to move about the central axis. Furthermore, the second driving part comprises a supporting rod passing through the circular arc through-slot to hold the alignment claw and a driving source for driving the supporting rod to translate along the circular arc through-slot.

In yet another exemplary embodiment of the present invention, the alignment device further comprises a detecting part configured to detect whether a fiber passing through the ferrule extends along the central axis and a controlling part configured to control the ferrule rotating part to rotate the ferrule based on a signal from the detecting part indicating the fiber does not extend along the central axis. The detecting part may comprise a CCD camera.

According to another aspect of the present invention, there is provided a fiber alignment machine comprising the alignment device as described above and a first ferrule grip device which comprises a first grip claw and is configured to grip a ferrule out of a ferrule clamp via the first grip claw and then to move the gripped ferrule to the ferrule holding part.

In an exemplary embodiment of the present invention, the first ferrule grip device comprises a first grip claw support comprising: a first support part configured to move the first grip claw in a first direction; a second support part configured to move the first grip claw in a second direction, the first and the second directions being adapted to define a horizontal plane; and a third support part configured to move the first grip claw in a third direction perpendicular to the first and second directions.

In another exemplary embodiment of the present invention, the fiber alignment machine comprises two alignment devices as described above and the first ferrule grip device is configured to move the first grip claw from the ferrule clamp towards above either of the alignment devices.

In yet another exemplary embodiment of the present invention, the alignment device further comprises a holding part for an aligned ferrule clamp and a second ferrule grip device which comprises a second grip claw and is configured to grip the aligned ferrule out of the ferrule holding part via the second grip claw and then to move the aligned ferrule to the holding part for the aligned ferrule clamp. Further, the second ferrule grip device comprises a second grip claw support comprising: a fourth support part configured to move a second grip claw in a first direction; a firth support part configured to move the second grip claw in a second direction, the first and second directions being adapted to define a horizontal plane; and a sixth support part configured to move the second grip claw in a third direction perpendicular to the first and second directions.

In still another exemplary embodiment of the present invention, the holding part for the aligned ferrule clamp comprises a rotating platform supporting at least two aligned ferrule clamps.

In yet another exemplary embodiment of the present invention, the alignment device further comprises a first conveyor adapted to transport the ferrule clamp, the first conveyor comprising transporting claws adapted to grip the ferrule clamp and being configured to transport the ferrule clamp to a position where the first grip claw is adapted to grip the ferrule in the ferrule clamp. Further, the first conveyor comprises a first transporting portion and a second transporting portion adjacent to the first transporting portion, a transporting direction of the first transporting portion being perpendicular to that of the second transporting portion, wherein the transporting claws move the ferrule clamp from the first transporting portion to the second transporting portion. Furthermore, the second transporting portion comprises a carrying bracket carrying the ferule clamp and a second transportation driving portion adapted to drive the carrying bracket in the transporting direction of the second transporting portion to move between a receiving position for receiving the ferrule clamp from the first transporting portion and a grip position in which the first grip claw is adapted to grip the ferrule in the ferrule clamp. The fiber alignment machine may further comprise a second conveyor adapted to transport the ferrule clamp from the carrying bracket.

In still another exemplary embodiment of the present invention, the transporting claws comprise a first transporting claw and a second transporting claw, both of which is adapted to move in the transporting direction of the first transporting portion, the first transporting claw being adapted to move the ferrule clamp from the first transporting portion to the carrying bracket, and the second transporting claw being adapted to move the ferrule clamp from the carrying bracket to the second conveyor. The second transporting claw clamps the ferrule clamp located on the carrying bracket in the receiving position from the carrying bracket.

In yet another exemplary embodiment of the present invention, the first transporting portion is a first conveyor belt, the second conveyor is a second conveyor belt, and the second conveyor belt is arranged to be below and spaced from the first conveyor belt.

In still another exemplary embodiment of the present invention, a transporting direction of the first conveyor belt is opposite to that of the second conveyor belt.

In yet another aspect of the present invention, there is provided a fiber alignment method comprising: holding a ferrule in a ferrule holding part in a vertical direction; rotating the ferrule about a central axis thereof by a predetermined angle; and marking on an outer surface the ferrule rotated by the predetermined angle.

The method may further comprise detecting whether a fiber passing through the ferrule extends along the central axis thereof and rotating the ferrule about the central axis based on detecting results.

In an exemplary embodiment of the present invention, the ferrule comprises a ferrule body and the fiber passing through the ferrule body, the ferrule body comprising a cylindrical portion and an equilateral polygonal portion, the predetermined angle is a central angle of the equilateral polygonal portion, and the mark is made on a side surface of the equilateral polygonal portion.

In another exemplary embodiment of the present invention, detecting whether a fiber passing through the ferrule extends along the central axis thereof comprises determining whether the fiber is a defective fiber.

The method may further comprise removing the ferrule to a reject collecting box if it is determined that the fiber is a defective fiber.

In yet another exemplary embodiment of the present invention, rotating the ferrule about a central axis thereof by a predetermined angle comprises clamping the ferrule by a releasable alignment claw while rotating the alignment claw about the central axis by the predetermined angle.

In still another exemplary embodiment of the present invention, the method further comprises gripping a ferrule from a ferrule clamp to a ferrule holding part via a first grip claw before holding a ferrule in the ferrule holding in a vertical direction. Further, the method further comprises transporting the ferrule clamp to a position where the first grip claw is adapted to grip the ferrule. Furthermore, the method further comprises: removing the unloaded ferrule clamp; transporting another ferrule clamp to the position where the first grip claw is adapted to grip the ferrule; and gripping the ferrule from said another ferrule clamp to the ferrule holding part via the first grip claw.

The method as described above may further comprise moving the marked ferrule from the ferrule holding part to an aligned ferrule clamp via a second grip claw. Further, the aligned ferrule clamp comprises at least two aligned ferrule clamps disposed on a rotating platform, and the method further comprises after one of the aligned ferrule clamps is fully loaded with ferrules, rotating the rotating platform to rotate another aligned ferrule clamp to a position where the second grip claw is adapted to load the ferrule.

The present invention also relates to a fiber alignment machine comprising: a first ferrule clamp conveyor adapted to transport a first ferrule clamp loaded with a fiber ferrule; an alignment device adapted to rotate the fiber ferrule and mark on an outer surface of the fiber ferrule to determine the outer surface of the fiber ferrule towards which a fiber is deflected; a first ferrule conveyor adapted to transport the ferrule from the first ferrule clamp to the fiber alignment device; a ferrule clamp reloading device having a second ferrule clamp adapted to load the aligned ferrule; and a second ferrule conveyor adapted to transport the aligned ferrule from the alignment device to the second ferrule clamp. The first ferrule clamp may be a PC polishing clamp, and the second ferrule clamp may be an APC polishing clamp. The alignment device may be the alignment device as described above. The fiber alignment machine may further comprise a second ferrule clamp conveyor for transporting the unloaded first ferrule clamp.

The present invention also relates to a fiber alignment method comprising: transporting a first ferrule clamp on which a fiber ferrule is loaded; supplying the fiber ferrule to an alignment device; rotating the fiber ferrule by the alignment device and marking on an outer surface of the fiber ferrule to determine the outer surface of the fiber ferrule towards which a fiber is deflected; and loading the aligned ferrule to a second ferrule clamp. The first ferrule clamp may be a PC polishing clamp, and the second ferrule clamp may be an APC polishing clamp.

In an exemplary embodiment of the present invention, rotating the fiber ferrule by the alignment device and marking on an outer surface of the fiber ferrule to determine the outer surface of the fiber ferrule towards which a fiber is deflected further comprises determining whether the fiber is a defective fiber. Further, the method further comprises removing the ferrule to a reject collecting box if it is determined that the fiber is a defective fiber.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative structural view of an alignment device for fiber ferrules according to an exemplary embodiment of the present invention;

FIG. 2 is an illustrative partial enlarged view of the alignment device shown in FIG. 1;

FIG. 3 is another illustrative view of the alignment device shown in FIG. 2;

FIG. 4 is an illustrative view of a ferrule grip device according to an exemplary embodiment of the present invention;

FIG. 5 is an illustrative partially enlarged view of the ferrule grip device shown in FIG. 4;

FIG. 6 is an illustrative structural view of a ferrule clamp grip device according to an exemplary embodiment of the present invention;

FIG. 7 is an illustrative partially enlarged view of the ferrule clamp grip device shown in FIG. 6;

FIG. 8 is an illustrative structural view of a holding part for an aligned ferrule clamp according to an exemplary embodiment of the present invention;

FIG. 9 is an illustrative structural view showing an aligned ferrule is moved onto an aligned ferrule clamp according to an exemplary embodiment of the present invention;

FIG. 10 is an illustrative partially enlarged view of FIG. 9; and

FIG. 11 is a perspective view of a fiber alignment machine according to an exemplary embodiment of the present invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

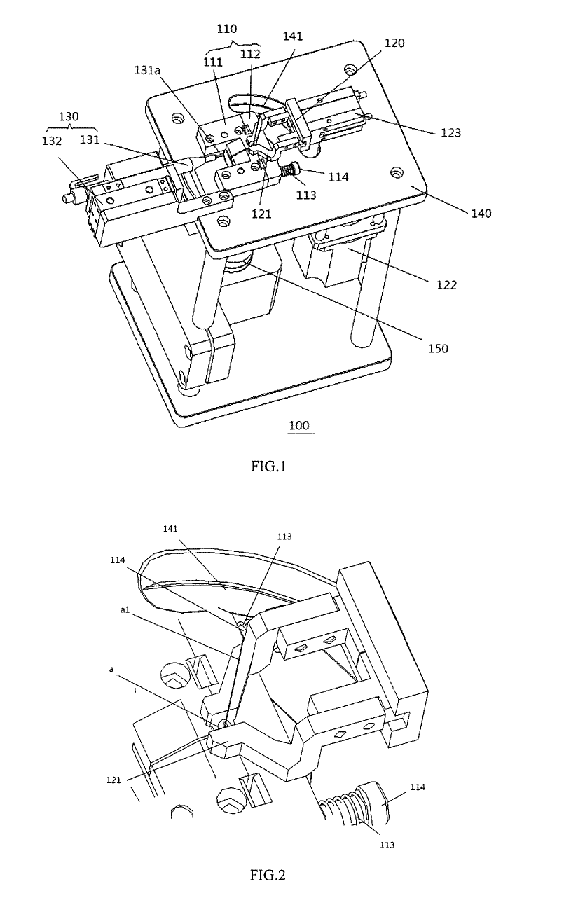

An alignment device for a fiber ferrule according to an exemplary embodiment of the present invention will be described with reference to FIGS. 1 to 3.

As shown in FIGS. 1 to 3, an alignment device 100 for a fiber ferrule a comprises: a ferrule holding part 110 configured to hold the fiber ferrule in a manner that the fiber ferrule a is rotatable about its central axis; a ferrule rotating part 120 configured to rotate the ferrule a about the central axis by a predetermined angle; and a marking part 130 configured to mark on an outer surface of the ferrule rotated by the predetermined angle. The ferrule a has a fiber a1 passing therethrough and a ferrule body a2 having a cylindrical portion and an equilateral polygonal portion (see FIG. 5).

The ferrule a can be rotated by a desired angle through the alignment device as describe above, and then a mark can be made on the rotated ferrule a by the marking part to facilitate abutment of bare fibers in subsequent operations. For example, in a case where two ferrules to be abutted are both marked, a good abutment of two bare fibers can be ensured by aligning marks on these ferrules.

The marking part 130 may comprise a marking pen 131 and a first driving part 132 for driving the marking pen 131 to move, so that a penpoint 131 a of the marking pen 131 move towards and away from the ferrule. It should be noted that the marking pen shown in FIG. 1 is only illustrative. The making pen may take any other suitable forms. In addition, the marking pen may also be replaced with other marking means as long as markers can be made at a suitable position on the outer surface of the ferrule.

As illustrated in FIGS. 1 and 2, the ferrule holding part 110 has a first clamping block 111 and a second clamping block 112 opposite to each other, each of which is provided with one recess. Both recesses of the first and second clamping blocks 111 and 112 are opposite to each other to form a portion for partially inserting the ferrule body of the ferrule (the recesses opposite to each other correspond to a position where the ferrule is located). In an exemplary embodiment of the present invention, in a case where a lower part of the ferrule body is a cylinder for example, the portion for partially inserting the ferrule body of the ferrule is a circular hole to facilitate rotating the ferrule body therein. As appreciated by those skilled in the art, a size of the portion for partially inserting the ferrule body of the ferrule or the circular hole is designed to facilitate receiving the ferrule body easily and to allow the ferrule body to rotate therein while also holding the ferrule body a2 in a vertical position. Referring to FIG. 5, an upper part of the ferrule a2 is an equilateral polygonal portion and the lower part thereof is a cylindrical portion. A radial dimension of the equilateral polygonal portion is larger than a diameter of the cylindrical portion. Therefore, when the ferrule a is held in the portion for partially inserting the ferrule body, the cylindrical portion is located within the portion and the equilateral polygonal portion is supported on an upper edge of the portion.

As shown in FIG. 1, the first clamping block 111 is elastically abutted against the second clamping block 112, which may prevent the ferrule from shaking in a right-left direction in FIG. 1. More particularly, the first clamping block 111 is provided with a threaded hole, and the second clamping block 112 is provided with a through-hole. One end of bolt 114 provided with a spring 113 passes through the through-hole to threadedly engage with the threaded hole, while the spring 113 is compressed between the other end of the bolt 114 and the second clamping block 112 to apply a pushing force to the second clamping block 112 towards the first clamping block 111. As depicted in FIG. 2, a pair of blots 114 are provided.

In the embodiment as described above, the ferrule holding part 110 consists of the first and second clamping blocks. However, the ferrule holding part 110 may also be one piece having an inserting hole for holding the ferrule.

The ferrule rotating part 120 will be described in details below.

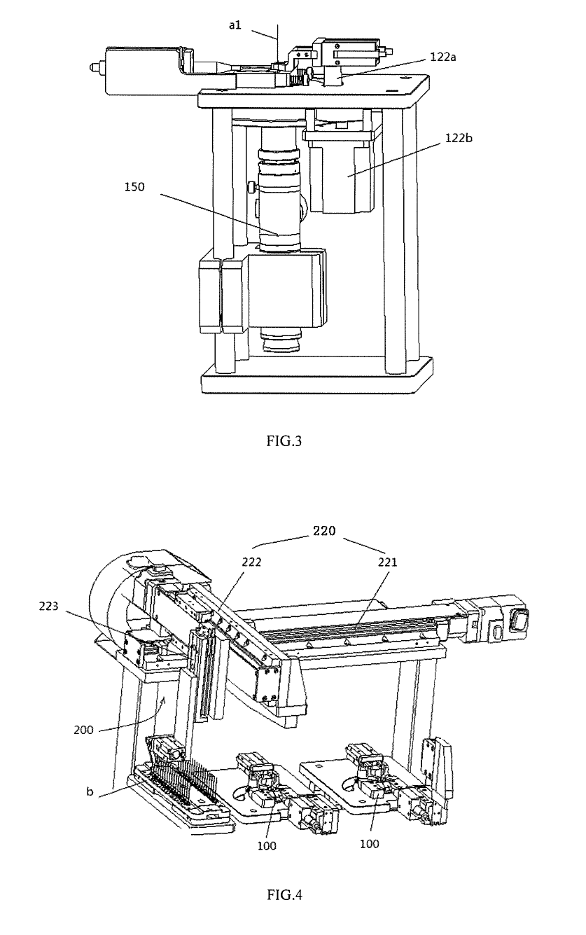

As illustrated in FIGS. 1 to 3, the ferrule rotating part 120 comprises an alignment claw 121 adapted to releasably clamp an upper end of the ferrule a and a second driving part 122 for driving the alignment claw 121 to move along a circular arc about the central axis. In FIGS. 1 and 3, the second driving part 122 is disposed below an alignment platform 140.

The alignment device 100 may further comprise the alignment platform 140 provided with a circular arc shape through-slot 141 which guides the alignment claw 121 to move about the central axis. The second driving part 122 includes a supporting rod 122a passing through the circular arc through-slot 141 to hold the alignment claw 121 and a driving source 122b for driving the supporting rod 122a to translate along the circular arc through-slot 141. The above ferrule rotating part 120 is given as a specific example only. In an exemplary embodiment of the present invention, the second driving part 122 may also be disposed above the alignment platform 140. In this case, a support for holding the alignment claw 121 may be driven along a circular arc with a circular center being on the central axis as described above to rotate the alignment claw 121.

A clamping operation of the alignment claw 121 is controlled or implemented by a driving means 123.

In an exemplary embodiment of the present invention, as shown in FIGS. 1 and 3, the alignment device 100 may further comprise a detecting part 150 configured to detect whether the fiber a1 passing through the ferrule a extends along the central axis and a controlling part configured to control the ferrule rotating part to rotate the ferrule based on a signal from the detecting part indicating the fiber does not extend along the central axis. The detecting part may include a CCD camera.

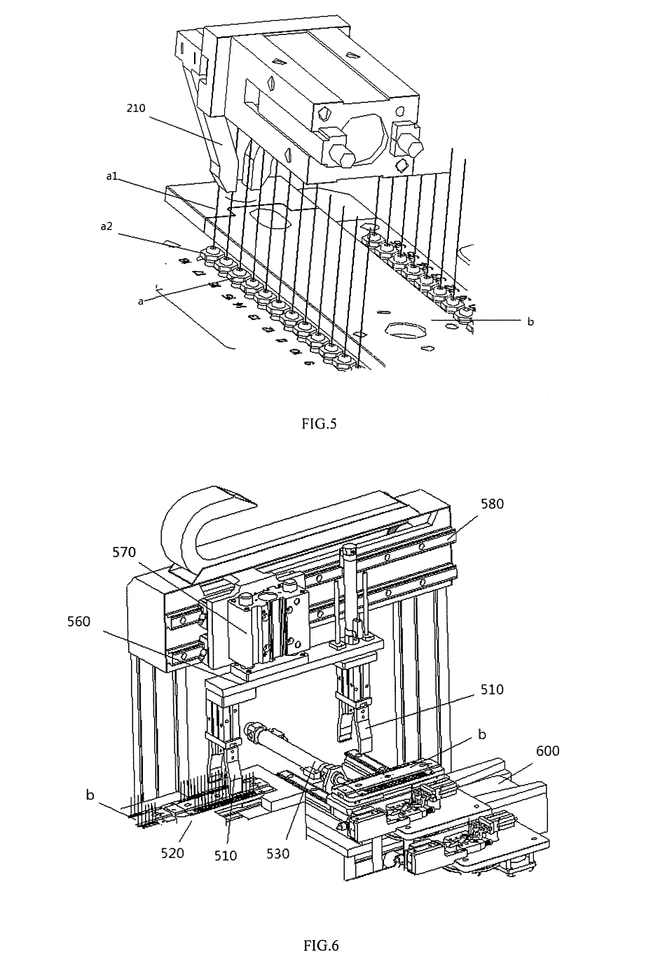

The present invention also relates to a fiber alignment machine 1000 as shown in FIG. 11 for example. Referring to FIGS. 4 and 5, the fiber alignment machine 1000 may comprise the alignment device 100 as described above and a first ferrule grip device 200 which includes a first grip claw 210 and is configured to grip a ferrule a out of a ferrule clamp b via the first grip claw 210 and then to move the gripped ferrule to the ferrule holding part 110.

As illustrated in FIG. 4, the first ferrule grip device 200 comprises a first grip claw support 220 which includes: a first support part 221 configured to move the first grip claw 210 in a first direction, for example, in a X direction in FIG. 11; a second support part 222 configured to move the first grip claw 210 in a second direction, for example, in a Y direction in FIG. 11, the first direction and the second direction being adapted to define a horizontal plane; and a third support part 223 configured to move the first grip claw 210 in a third direction perpendicular to the first and second directions, for example, in a Z direction in FIG. 11.

The first grip claw 210 can move in three dimensions via the first grip claw support 220.

As shown in FIG. 4, the fiber alignment machine 1000 comprises two alignment devices 100. The first ferrule grip device 200 is configured to move the first grip claw 210 from the ferrule clamp b towards above either of the alignment devices 100.

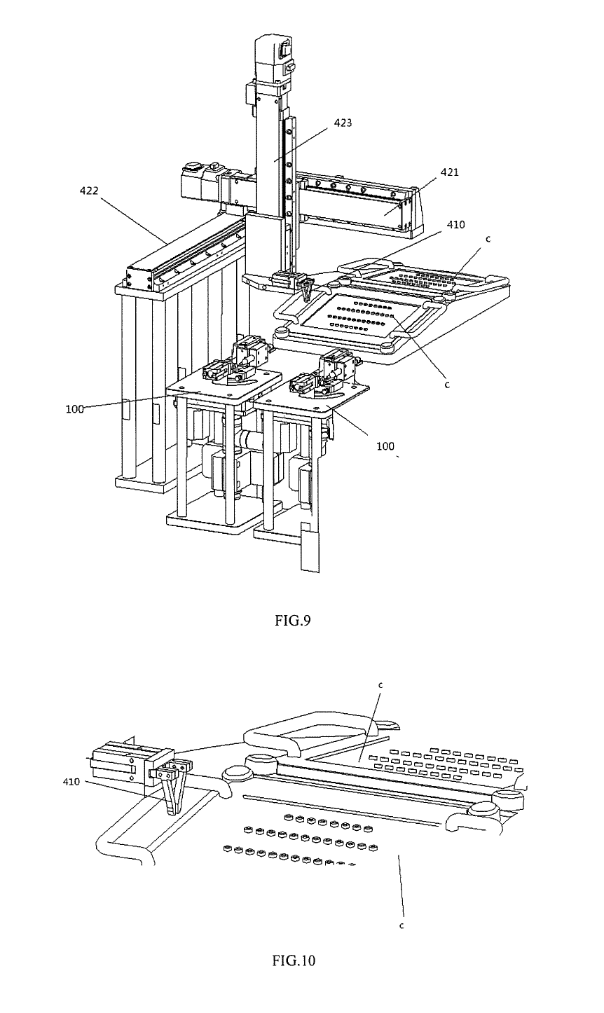

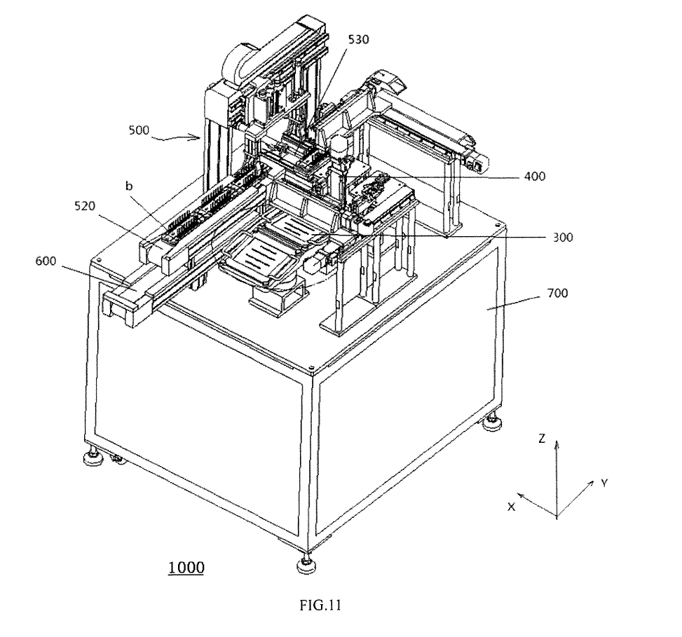

Referring to FIGS. 9 to 11, the fiber alignment machine 100 may further comprise a holding part 300 for an aligned ferrule clamp and a second ferrule grip device 400 which includes a second grip claw 410 and is configured to grip the ferrule a out of the ferrule holding part via the second grip claw 410 and then to move the ferrule to the holding part 300 for the aligned ferrule clamp.

As depicted in FIG. 9, the second ferrule grip device 400 comprises a second grip claw support which includes: a fourth support part 421 configured to move the second grip claw 410 in the first direction; a firth support part 422 configured to move the second grip claw 410 in the second direction; and a sixth support part 423 configured to move the second grip claw 410 in the third direction.

As shown in FIG. 8, the holding part for the aligned ferrule clamp 300 comprises a rotating platform 310 supporting at least two aligned ferrule clamps c. In a case where one of the ferrule clamps c has been fully loaded, it is possible to move the other ferrule clamp c to a position to be loaded by the rotating platform 310. The rotating platform 310 is driven by a motor 320.

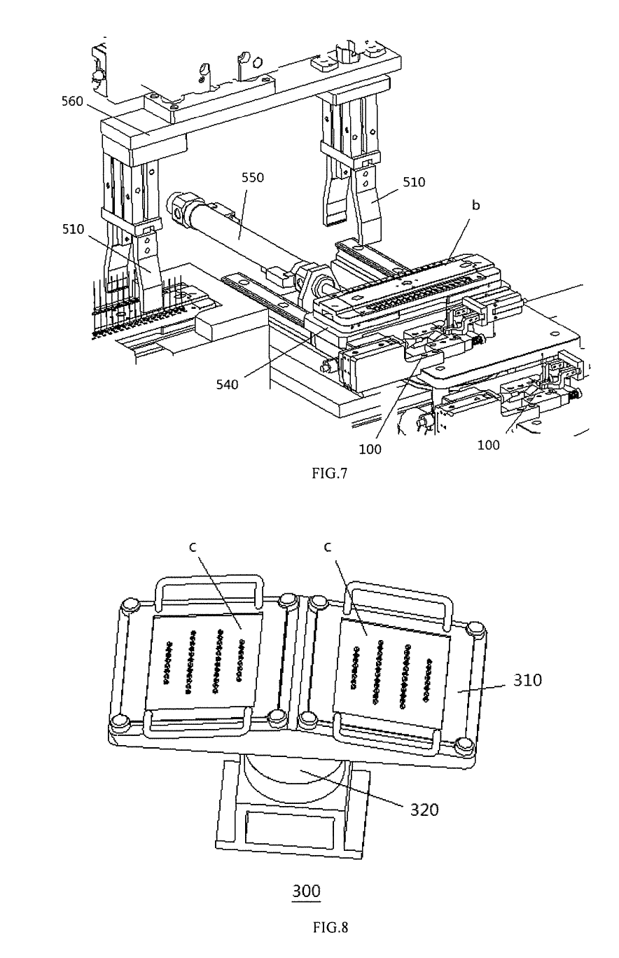

As illustrated in FIGS. 6, 7 and 11, the fiber alignment machine 1000 may further comprise a first conveyor 500 adapted to transport the ferrule clamp c loaded with the ferrule. The first conveyor 500 comprises transporting claws 510 adapted to grip the ferrule clamp b and is configured to transport the ferrule clamp b to a position where the first grip claw 210 is adapted to grip the ferrule in the ferrule clamp b.

More particularly, the first conveyor 500 includes a first transporting portion 520 (for example, see FIG. 11) and a second transporting portion 530 adjacent to the first transporting portion 520 (see FIGS. 6 and 11 for example). A transporting direction of the first transporting portion 520 is perpendicular to that of the second transporting portion 530. The transporting claws 510 move the ferrule clamp b from the first transporting portion 520 to the second transporting portion 530.

The transporting claws 510 are supported by a support 560. The support 560 is connected to a driving portion 570 which is movable along rails 580, i.e., movable in a right-left direction in FIG. 6. In an exemplary embodiment of the present invention, the support 560 may also be movable relative to the driving portion 570, i.e., translatable in up-and-down direction, as shown in FIG. 6.

Referring to FIGS. 6 and 7, the second transporting portion 530 may further comprise a carrying bracket 540 carrying the ferule clamp b and a second transportation driving portion 550 adapted to drive the carrying bracket in the transporting direction of the second transporting portion 530 to move between a receiving position for receiving the ferrule clamp from the first transporting portion 520 and a grip position where the first grip claw 210 is adapted to grip the ferrule in the ferrule clamp b. Particularly, in FIG. 7, the second transportation driving portion 550 drives the carrying bracket 540 to move between in a position as shown in FIG. 7 which corresponds to the grip position in which the first grip claw 210 is adapted to grip the ferrule in the ferrule clamp b and a position where the carrying bracket 540 is positioned to be aligned with the ferrule clamp b on the first transporting portion 520 and which corresponds to the receiving position.

As shown in FIGS. 6 and 11, the fiber alignment machine 1000 may further comprise a second conveyor 600 adapted to transport the unloaded ferrule clamp from the carrying bracket 540.

As illustrated in FIGS. 6 and 7, the transporting claws 510 include two transporting claws each of which is adapted to move in the transporting direction of the first transporting portion. One of the two transporting claws, for example, the left transporting claw in FIG. 7, is adapted to move the ferrule clamp b from the first transporting portion 520 to the carrying bracket 540 when the carrying bracket 540 is in the receiving position, and the other transporting claw, for example, the right transporting claw in FIG. 7, is adapted to move the ferrule clamp b from the carrying bracket 540 to the second conveyor 600.

In an exemplary embodiment of the present invention, the first transporting portion 520 is a first conveyor belt, and the second conveyor 600 is a second conveyor belt which is arranged below and spaced from the first conveyor belt, as illustrated in FIG. 11. A transporting direction of the first conveyor belt may be opposite to that of the second conveyor belt.

According to the above, the present invention also relates to a fiber alignment method comprising: holding a ferrule in a ferrule holding part 110 in a vertical direction; rotating the ferrule about a central axis thereof by a predetermined angle; and marking on an outer surface the ferrule which has been rotated by the predetermined angle.

The method as described above may further comprise detecting whether a fiber passing through the ferrule extends along the central axis thereof and rotating the ferrule about the central axis based on detecting results.

In the above method, the ferrule comprises a ferrule body and the fiber passing through the ferrule body, the ferrule body having a cylindrical portion and an equilateral polygonal portion. The predetermined angle is a central angle of the equilateral polygonal portion. The mark is made on a side surface of the equilateral polygonal portion.

In the method as described above, rotating the ferrule about a central axis thereof by a predetermined angle comprises clamping the ferrule by a releasable alignment claw while rotating the alignment claw about the central axis by the predetermined angle.

In the above method, the method further comprises gripping a ferrule from a ferrule clamp to a ferrule holding part via a first grip claw before holding a ferrule in the ferrule holding in a vertical direction.

The method as described above may further comprise transporting the ferrule clamp to a position where the first grip claw is adapted to grip the ferrule. Further, the above method further comprises: removing the unloaded ferrule clamp; transporting another ferrule clamp to the position in which the first grip claw is adapted to grip the ferrule; and gripping the ferrule from said another ferrule clamp to the ferrule holding part via the first grip claw.

The method as described above may further comprise moving the marked ferrule from the ferrule holding part to an aligned ferrule clamp via a second grip claw.

In the above method, the aligned ferrule clamp comprises at least two aligned ferrule clamps disposed on a rotating platform. The method may further comprise: after one of the aligned ferrule clamps is fully loaded with ferrules, rotating the rotating platform to rotate the other aligned ferrule clamp to a position where the second grip claw is adapted to be load with the ferrule.

In an exemplary embodiment of the present invention, the aligned ferrule clamps may be an angular polishing (APC) ferrule clamps, and thus can realize a seamlessness link of the fiber alignment with the angular polishing.

In an exemplary embodiment of the present invention, the grip claw and the alignment claw may be an air-powered claw, and may also be any other type such as hydraulic or electrical clamping claws.

Referring to FIG. 11, the present invention provides a fiber alignment machine comprising two conveyor belts as generally denoted at 520 and 600 in FIG. 11 and three workstations. One of the conveyor belts is used to transport a fully loaded PC polishing clamp, and the other conveyor belt is used to transport the unloaded PC polishing clamp. Among the three workstations, a first workstation as generally denoted at 520, 530, 510, 560 and 670 as shown in FIG. 6 is used to realize an unloading of the PC polishing clamp and a fiber ferrule, a second workstation as generally denoted at 100 in FIG. 4 is used to perform an alignment on a ceramic ferrule, and a third workstation as denoted at 421, 422, 423, 410, c and the like in FIG. 9 is used to reload the ceramic ferrule and achieve an angular polishing. Compared to the conventional fiber alignment technology, the above structure can realize the seamlessness link of the fiber alignment with the angular polishing, and the unloading and reloading of the fiber ferrule can be completely mechanized, which greatly increases production efficiency and decreases labor costs as well.

More particularly, referring to FIG. 11, the fiber alignment machine mainly comprises a machine control box 700, a PC polishing clamp conveyor belt for unloaded ferrule clamps (corresponding to the second conveyor 600), a fully-loaded PC polishing clamp conveyor belt (corresponding to the first conveyor 520), a PC polishing clamp movable device (corresponding to the first ferrule grip device 200), a ceramic ferrule grip device (corresponding to the first grip claw 210 in FIG. 5 and the second grip claw 410 in FIG. 9), an automatic alignment device 100, an APC polishing clamping and loading stage (corresponding to the holding part 300 for the aligned ferrule clamp) and the like. The PC polishing clamp movable device mainly comprises two air claws corresponding to the two transporting claws 510 in FIGS. 6 and 7 and rails 580 to realize two-dimensional movement and to move the fully-loaded PC polishing clamp from the fully-loaded PC polishing clamp conveyor belt onto an unloading stage corresponding to the carrying bracket 540 (in a case where the carrying bracket 540 is not aligned with the fully-loaded PC polishing clamp conveyor belt, the second transportation driving portion 550 in FIG. 7 may drive the carrying bracket 540) and then to further move the unloaded PC polishing clamp to the conveyor belt for unloaded ferrule clamps. An actuator for the ceramic ferrule grip device is an air claw, on one hand to unload a ceramic ferrule from the PC polishing clamp to the automatic alignment stage for example via the first grip claw 210, and on the other hand to clamp and load the aligned ceramic ferrule into the APC polishing clamp for example via the second grip claw 410. The automatic alignment device comprises an automatic alignment stage 140 (see FIG. 1), a visual detection CCD corresponding to the detecting part 150 in FIG. 3, a alignment air claw corresponding to the alignment claw 121 in FIG. 1, a rotating motor corresponding to the driving device 123, a marker pen 131 and the like. The visual detection CCD detects concentricity of the fiber. If deviating from the central axis of the ceramic ferrule, a position of the fiber ferrule is regulated via the alignment claw, and one side of a bare fiber close to an edge of the ceramic ferrule is regulated to face the marker pen, and then the marker pen is driven by a cylinder corresponding to the first driving part 132 to move to an outside of the ceramic ferrule and mark on an surface thereof. The CCD detection may further find out defective fibers, and at a workstation for an automatic alignment, the defective fibers may be classified and placed into different reject collecting boxes. The APC polishing clamping and loading stage includes a DD motor 320, an APC polishing clamp rotating plate corresponding to the rotating platform 310, an APC polishing clamp and the like. The APC polishing clamp rotating plate is used to quickly rotate to replace one fully-loaded APC polishing clamp with another unloaded APC polishing clamp.

An operation of the fiber alignment machine shown in FIG. 11 will be described below.

S1. transporting the PC polishing clamp b from the first transporting portion 520 to the vicinity of the second transporting portion 530.

S2. unloading the PC polishing clamp b via the left grip claw 510 in FIG. 6 and then unloading the ceramic ferrule, which includes:
a. moving the left grip claw 510 in FIG. 6 to grip the PC polishing clamp b away from the first transporting portion 520 and placing the PC polishing clamp b on the carrying bracket 540 of the second transporting portion 530;
b. driving the PC polishing clamp b through the second transportation driving portion 550 to be moved to a gripable range of the first grip claw 210; and
c. sequentially gripping the ceramic ferrule inserted with the fiber and placing the ceramic ferrule on the automatic alignment stage, particularly, on the ferrule holding part 110, be means of the first grip claw 210.

S3. moving the right transporting claw 510 in FIG. 6 to grip the unloaded PC polishing clamp b and place the unloaded PC polishing clamp b on the conveyor belt for unloaded ferrule clamps, i.e, the second conveyor 600, and then moving the unloaded PC polishing clamp b away from the working platform.

S4. regulating the central axis of the fiber ferrule including
a. scanning the ferrule inserted with the fiber by the visual detection CCD which corresponds to the detecting part 150 and determining whether the fiber is located on the central axis of the ferrule;
b. if the fiber is not located on the central axis of the ferrule, regulating, i.e. rotating, the ferrule via the alignment claw 121, and regulating one side of a bare fiber close to the edge of the ferrule towards the marker pen;
c. driving the marker pen by the cylinder, i.e., the first driving part 132, to the outside of the ferrule and marking on the surface thereof;
d: if the CCD detects that the fiber is located in the central axis of the ferrule, directly proceeding to S5;
e: if the CCD detects that the fiber inserted into the ferrule is a defective fiber, placing the defective fiber into different reject collecting boxes via the second grip claw 410 according to a defect classification.

S5: reloading the ferrule comprising
a. gripping and placing the ferrule which has been aligned or does not need to be aligned onto the APC polishing clamp c via the second grip claw 410;
b. after one APC polishing clamp c has been loaded, pressing a rotating button so that the rotating platform 310 rotates by 180 degrees so as to cause the another APC polishing clamp c closer to the second grip claw 410.

Compared to the prior art, the method as described above can achieve at least one of the following advantages:

saving labor time and labor costs;

realizing the seamlessness link of the fiber alignment with the angular polishing;

completely mechanizing the unloading and reloading of the fiber ferrule;

improving the production efficiency, since the fiber alignment, the unloading and reloading operations are independent from each other.

The visual detection CCD may find out the defective fibers and classify and place them into different reject collecting boxes at the workstation for the automatic alignment.

Concerning the above, the present invention also provides a fiber alignment method comprising: transporting a first ferrule clamp on which a fiber ferrule is loaded; supplying the fiber ferrule to an alignment device; rotating the fiber ferrule by the alignment device and marking on an outer surface of the fiber ferrule to determine the outer surface of the fiber ferrule towards which a fiber is deflected; and loading the aligned ferrule to a second ferrule clamp. In an exemplary embodiment of the present invention, the first ferrule clamp is a PC polishing clamp and the second ferrule clamp is an APC polishing clamp. In an exemplary embodiment of the present invention, rotating the fiber ferrule by the alignment device and marking on an outer surface of the fiber ferrule to determine the outer surface of the fiber ferrule towards which a fiber is deflected further comprises determining whether the fiber is a defective fiber. If it is determined that the fiber is a defective fiber, the fiber ferrule may be removed to a reject collecting box.

The present invention further provides a fiber alignment machine comprising: a first ferrule clamp conveyor adapted to transport a first ferrule clamp loaded with a fiber ferrule; an alignment device adapted to rotate the fiber ferrule and mark on an outer surface of the fiber ferrule to determine the outer surface of the fiber ferrule towards which a fiber is deflected; a first ferrule conveyor adapted to transport the ferrule from the first ferrule clamp to the fiber alignment device; a ferrule clamp reloading device having a second ferrule clamp adapted to load the aligned ferrule; and a second ferrule conveyor adapted to transport the aligned ferrule from the alignment device to the second ferrule clamp. The first ferrule clamp may be a PC polishing clamp and the second ferrule clamp may be an APC polishing clamp. The fiber alignment machine may further comprise a second ferrule clamp conveyor for transporting the unloaded first ferrule clamp.

In the present invention, a marker may be made on an outer surface of the ferrule toward which the fiber is deflected or on an outer surface of the ferrule from which the fiber is deflected as long as the marked outer surface can allow an operator to determine a direction in which the fiber is deflected. Therefore, the marked outer surface as used in the step of rotating the fiber ferrule by the fiber alignment device and marking on an outer surface of the fiber ferrule to determine the outer surface of the fiber ferrule towards which a fiber is deflected may be same as or different from the outer surface toward which the fiber is deflected.

Although several exemplary embodiments have been shown and described, it would be appreciated by those skilled in the art that various changes or modifications may be made in these embodiments without departing from the principle and spirit of the disclosure, the scope of which is defined in the claims and their equivalents.

What is claimed is:

1. An alignment device for a fiber ferrule, comprising
a ferrule holding part configured to hold the fiber ferrule in a manner that the fiber ferrule is rotatable about its central axis;
a ferrule rotating part configured to rotate the ferrule about the central axis by a predetermined angle; and
a marking part configured to mark on an outer surface of the ferrule rotated by the predetermined angle.

2. The alignment device according to claim 1, wherein
the marking part comprises a marking pen and a first driving part for driving the marking pen so that a penpoint of the marking pen moves towards and away from the ferrule.

3. The alignment device according to claim 2, wherein
the ferrule holding part comprises a first clamping block and a second clamping block opposite to each other, each of which is provided with one recess; and
the recesses of the first and second clamping blocks are opposite to each other to form a portion for partially inserting a ferrule body of the ferrule.

4. The alignment device according to claim 3, wherein
the portion for partially inserting the ferrule body of the ferrule comprises a circular hole.

5. The alignment device according to claim 3, wherein
the first clamping block is elastically abutted against the second clamping block.

6. The alignment device according to claim 1, wherein
the ferrule rotating part comprises an alignment claw adapted to releasably clamp an upper end of the ferrule and a second driving part for driving the alignment claw to move along a circular arc about the central axis.

7. The alignment device according to claim 6, wherein
the alignment device comprises an alignment platform provided with a circular arc shape through-slot which guides the alignment claw to move about the central axis.

8. The alignment device according to claim 7, wherein
the second driving part comprises a supporting rod passing through the circular arc through-slot to hold the alignment claw and a driving source for driving the supporting rod to translate along the circular arc through-slot.

9. The alignment device according to claim 1, further comprising:
a detecting part configured to detect whether a fiber passing through the ferrule extends along the central axis; and
a controlling part configured to control the ferrule rotating part to rotate the ferrule based on a signal from the detecting part indicating the fiber does not extend along the central axis.

10. A fiber alignment machine comprising:
the alignment device according to claim 1; and
a first ferrule grip device which comprises a first grip claw and is configured to grip a ferrule out of a ferrule clamp via the first grip claw and then to move the gripped ferrule to the ferrule holding part.

11. The fiber alignment machine according to claim 11, wherein
the fiber alignment machine comprises two alignment devices according to claim 1; and
the first ferrule grip device is configured to move the first grip claw from the ferrule clamp towards above either of the two alignment devices.

12. The fiber alignment machine according to claim 10, further comprising:
a holding part for an aligned ferrule clamp; and
a second ferrule grip device which comprises a second grip claw and is configured to grip the aligned ferrule out of the ferrule holding part via the second grip claw and then to move the aligned ferrule to the holding part for the aligned ferrule clamp.

13. The fiber alignment machine according to claim 12, wherein
the holding part for the aligned ferrule clamp comprises a rotating platform supporting at least two aligned ferrule clamps.

14. A fiber alignment method comprising holding a ferrule in a ferrule holding part in a vertical direction;
rotating the ferrule about a central axis thereof by a predetermined angle; and
marking on an outer surface the ferrule rotated by the predetermined angle.

15. The fiber alignment method according to claim 14, further comprising detecting whether a fiber passing through the ferrule extends along the central axis thereof; and
rotating the ferrule about the central axis based on detecting results.

16. The fiber alignment method according to claim 14, wherein
rotating the ferrule about a central axis thereof by a predetermined angle comprises clamping the ferrule by a releasable alignment claw while rotating the alignment claw about the central axis by the predetermined angle.

17. The fiber alignment method according to claim 14, further comprising
moving the marked ferrule from the ferrule holding part to an aligned ferrule clamp via a second grip claw.

18. The fiber alignment method according to claim 17, wherein
the aligned ferrule clamp comprises at least two aligned ferrule clamps disposed on a rotating platform; and
the method further comprises after one of the aligned ferrule clamps is fully loaded with ferrules, rotating the rotating platform to rotate another aligned ferrule clamp to a position where the second grip claw is adapted to load the ferrule.

19. A fiber alignment machine comprising
a first ferrule clamp conveyor adapted to transport a first ferrule clamp loaded with a fiber ferrule;
an alignment device adapted to rotate the fiber ferrule and mark on an outer surface of the fiber ferrule to determine the outer surface of the fiber ferrule towards which a fiber is deflected;
a first ferrule conveyor adapted to transport the ferrule from the first ferrule clamp to the fiber alignment device;
a ferrule clamp reloading device comprising a second ferrule clamp adapted to load the aligned ferrule; and
a second ferrule conveyor adapted to transport the aligned ferrule from the alignment device to the second ferrule clamp.

20. A fiber alignment method comprising
transporting a first ferrule clamp on which a fiber ferrule is loaded;
providing the fiber ferrule to an alignment device;
rotating the fiber ferrule by the alignment device and marking on an outer surface of the fiber ferrule to determine the outer surface of the fiber ferrule towards which a fiber is deflected; and
loading the aligned ferrule to a second ferrule clamp.
